(19) United States
(12) Patent Application Publication
(10) Pub. No.: US 2009/0040286 A1
(43) Pub. Date: Feb. 12, 2009

(54) PRINT SCHEDULING IN HANDHELD PRINTERS

(76) Inventors: Theresa Joy L. Tan, Cebu City (PH); Eduardo M. Gallofin, JR., Bacolod City (PH); Aldrin B. Manlosa, Cebu City (PH); Archibald P. Sayo, Singapore (SG); Michael D. Stilz, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/835,433

(22) Filed: Aug. 8, 2007

(51) Int. Cl. B41J 3/36

(52) U.S. Cl. 347/109

(57) ABSTRACT

Methods and apparatus include a handheld printer manipulated by an operator to print an image on a media. A controller correlates a location of a printhead to the image and causes printing or not, including referencing a memory of firing data for fluid firing actuators of the printhead. A position sensor provides input to the controller to assist in navigation. The controller figures an ideal position of a center of an actuator chip, defining the fluid firing actuators, and an actual position during use. Individual fluid firing actuators are known relative to the center by way of a calculated offset. Predicted positions, as well as ascertained velocities and accelerations are other noteworthy aspects. Resolving firing data for actual locations of each actuator is also contemplated.

### FIELD OF THE INVENTION

Generally, the present invention relates to handheld printers. Particularly, it relates to scheduling print jobs in handheld printers of the type able to print at random speeds, in random motion patterns and with random housing orientation relative to a media.

### BACKGROUND OF THE INVENTION

Traditional host-based printers print by firing ink to a paper through an ink cartridge or printhead that moves across the paper on a horizontal left-to-right or right-to left direction at an approximately constant speed. For these printers, most of the processing happens in the host (usually a computer), wherein print data, such as images or bitmaps, are processed and converted into a series of commands that tells the printer which ink nozzles to fire as the printhead moves horizontally across the paper.

This process, in which firing commands are generated and sent to the printhead, is commonly referred to as print scheduling. Since the printhead moves at a constant speed and in a fixed horizontal path, the positions of the ink nozzles at any point in time during printing are known beforehand. Thus, the commands sent to the printhead can be pre-processed and made ready even before the printhead starts moving across the paper.

The print scheduling process used in traditional printers, however, cannot be applied to handheld printers. As is known, handheld printers afford mobile convenience to users. Users determine the navigation path of a given swath of printing. In some instances, this includes random movement over a media. In others, it includes back-and-forth movement attempting to simulate a stationary printer. Regardless, printer speed, printer orientation, and path of motion over the media, to name a few, are irregular and virtually random.

Accordingly, a need exists in the art to schedule printing for handheld printers. The need must also contemplate robust, multi-directional Hid random speed and movement. Naturally, any improvements along such lines should further contemplate good engineering practices, such as relative inexpensiveness, stability, flexibility, ease of manufacturing, etc.

### SUMMARY OF THE INVENTION

The above-mentioned and other problems become solved by applying the principles and teachings associated with the hereinafter described print scheduling in handheld printers. Specifically, methods and apparatus contemplate handheld printers manipulated randomly or predictably over a media on which an image is printed. A controller correlates a location of a printhead to the image and causes printing or not, including referencing a memory of firing data for fluid firing actuators of the printhead. A position sensor provides input to the controller to assist in navigation. The controller figures an ideal position of a center of an actuator chip, defining the fluid firing actuators, and an actual position during use. Individual fluid firing actuators are known relative to the center of the chip by way of an offset. Predicted future housing positions, as well as ascertained housing velocities and accelerations are other noteworthy aspects. Appreciating individual actuators may or may not align perfectly over the media relative to the bit-map firing data, e.g., because of random operator movement, resolution between the firing data and actual locations of each actuator is also contemplated before firing.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a handheld printer during use;

FIG. 2 is a diagrammatic view in accordance with the present invention of a representative inkjet printhead for use in the handheld printer of FIG. 1;

FIG. 3 is a diagrammatic view in accordance with the present invention of a representative control arrangement of a handheld printer for scheduling printing;

FIG. 4 is a diagrammatic view in accordance with the present invention of representative processing modules of a handheld printer;

FIG. 5 is a diagrammatic view in accordance with the present invention of representative navigation data for scheduling printing in a handheld printer;

FIG. 6 is a diagrammatic view in accordance with the present invention of representative printing data for scheduling printing in a handheld printer;

FIG. 7 is a diagrammatic view in, accordance with the present invention of representative printing data in memory of a handheld printer;

FIG. 8 is a diagrammatic view in accordance with the present invention of another representative inkjet printhead and a center of a heater chip relative to ink nozzles for referencing print scheduling in a handheld printer;

FIG. 9 is a combined diagrammatic view and flow chart in accordance with the present invention for scheduling printing in a handheld printer;

FIG. 10 is a flow chart in accordance with the present invention of representative methodology for predicting future handheld printer locations;

FIG. 11 is a diagrammatic view in accordance with the present invention of representative calculations showing misalignment of actual printhead from an ideal position;

FIG. 12 is a diagrammatic view in accordance with the present invention of representative calculations showing a nozzle i relative to a media;

FIGS. 13A-13C are diagrammatic views in accordance with the present invention of representative valid nozzle positions;

FIG. 14 is a diagrammatic view in accordance with the present invention of representative methodology for nozzle-bitmap lookup in a handheld printer; and

FIG. 15 is a diagrammatic view in accordance with the present invention of a representative media for use with a handheld printer during printing.

### DETAILED DESCRIPTION OF THE PREFERRED EMBODIMENTS

In the following detailed description of the preferred embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, architectural, software and/or other changes may be made without departing from the scope of the present invention. In accordance with the present invention, methods and apparatus for scheduling printing in a handheld printer are hereafter described.

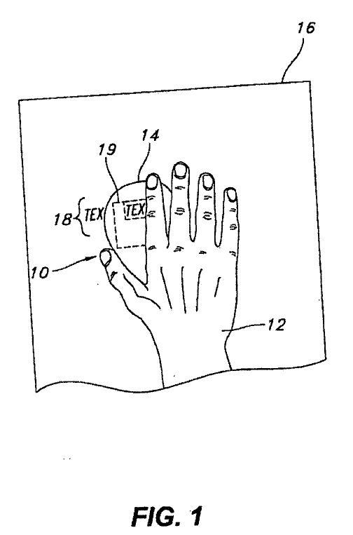

With reference to FIG. 1, a handheld printer of the invention having scheduled printing is given generically as 10. It includes a housing 14 that an operator 12 maneuvers or manipulates back and forth over a media 16 to print an image 18. In various embodiments, the image is text, figures, combinations of text and figures or the like. They are typified in color and/or black and white and formed of ink ejected or expelled from an internal printhead. Also, the printer optionally includes a viewable display panel 19 (dashed line) to assist the operator during printing, such as by showing the image being printed or by providing housekeeping menus, calibration routines, or other user features or options.

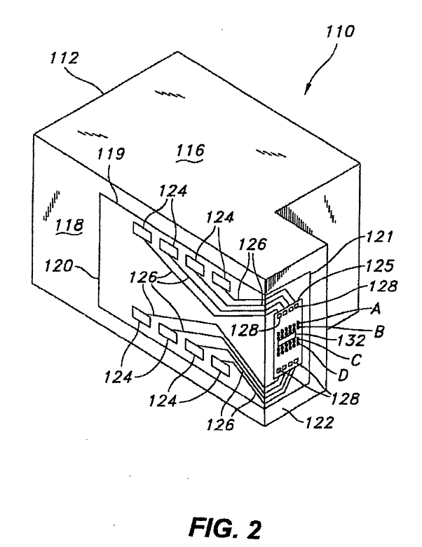

In FIG. 2, a representative inkjet printhead of the printer internal to the housing [14] is shown generally as 110. It includes its own housing 112 having a shape that depends upon the shape of the printer. The housing has at least one internal compartment 116 for holding an initial or refillable supply of ink. In one embodiment, the compartment contemplates a single chamber holding a supply of black, cyan, magenta or yellow ink. In other embodiments, it contemplates multiple chambers containing multiple different colored inks. In one instance, the multiple chambers include singular or plural supplies of cyan, magenta and yellow ink. It also contemplates separability from the housing 112 and/or printhead 110, despite being shown locally integrated within the housing.

At one surface 118 of the housing 112 is a portion 119 of a flexible circuit, especially a tape automated bond (TAB) circuit 120. At 121, another portion 121 is adhered to surface 122. Electrically, the TAB circuit 120 supports a plurality of input/output (I/O) connectors 124 for connecting an actuator chip 125 (also known as a heater chip or transducer chip) to the handheld printer during use. Pluralities of electrical conductors 126 exist on the TAB circuit to connect and short the I/O connectors 124 to the input terminals (bond pads 128) of the actuator chip 125 and skilled artisans know various techniques for facilitating this. In an exemplary embodiment, the TAB circuit is a polyimide material and the electrical conductors and connectors are copper or aluminum-copper. For simplicity, FIG. 2 shows eight I/O connectors 124, electrical conductors 126 and bond pads 128 but present day printheads have larger quantities and any number is equally embraced herein. Also skilled artisans will appreciate that the number of connectors, conductors and bond pads, while shown as equal to one another, may vary unequally in actual embodiments.

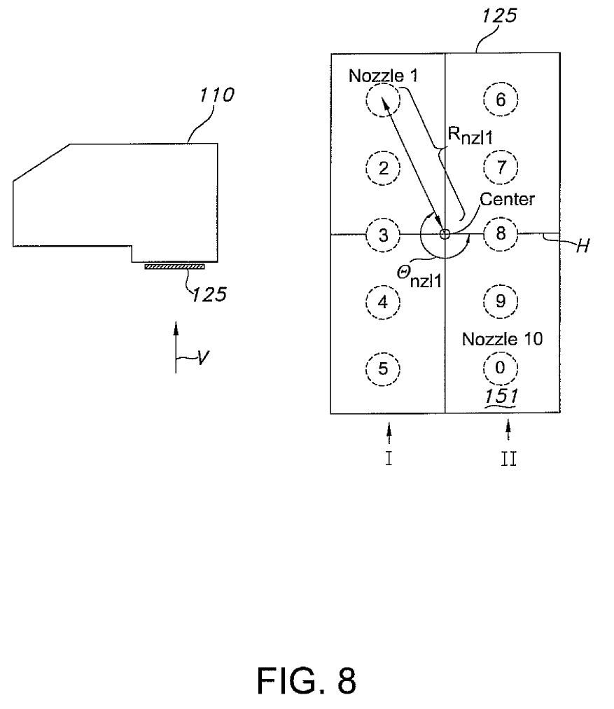

At 132, the actuator chip 125 contains at least one ink via that fluidly connects to the ink of the compartment 116. During printhead manufacturing, the actuator chip 125 is attached to the housing with any of a variety of adhesives, epoxies, etc., as is well known in the art. To eject ink, the actuator chip contains columns (column A-column D) of fluid firing actuators, such as thermal heaters. In other actuator chips, the fluid firing actuators embody piezoelectric elements, MEMs devices, and the like. In either, this crowded figure simplifies the actuators as four columns of six dots or darkened circles but in actual practice the actuators might number several dozen, hundred or thousand. Also, vertically adjacent ones of the actuators may or may not have a lateral spacing gap or stagger in between. In general, the actuators indeed have vertical spacing, such as about 1/300^{th}, 1/600^{th}, 1/1200^{th}, or 1/400^{th} of an inch along the longitudinal extent of the via. Further, the individual actuators are typically formed as a series of thin film layers made via growth, deposition, masking, patterning, photolithography and/or etching or other processing steps on a substrate, such as silicon. A nozzle member with pluralities of nozzles or nozzle holes (e.g., FIG. 8) is adhered to or fabricated as another thin film layer on the actuator chip such that the nozzle holes generally align with and are positioned above the actuators to eject ink at times pursuant to commands of a controller.

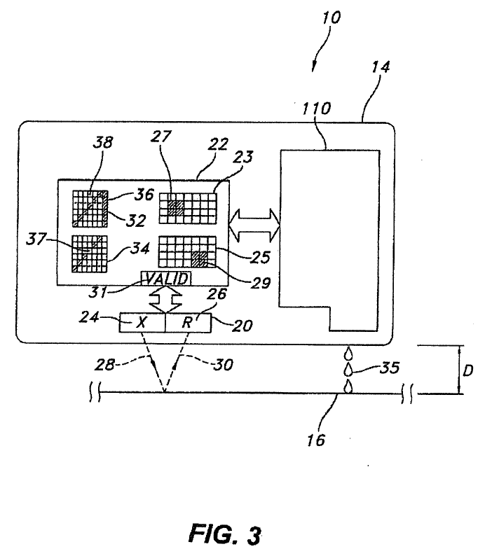

With reference to FIG. 3, a greatly exaggerated view of the handheld printer 10 shows a position sensor 20 and a controller 22. The position sensor, preferably of the optical type, includes a transmitter 24 and a receiver 26 that together shine light 28 and capture reflections 30 from the media 16. As is known, media surfaces have random textures (on a micro scale), which then create observable and reflected shadows upon application of light. Eventually, the manipulation of the signals obtained from the sensor regarding the shadows enables understanding the position or location of the housing, especially printhead 110, and is made known at the controller regardless of random or predictable movement or speed of the housing 14 by an operator. (Alternatively, a sophisticated x-y mechanical encoder could also provide position sensor information as could structures having energy in other than traditionally optical ranges. That is, optics may include infrared (IR) or radio frequency (RF) ranges and technology.)

In a basic sense, this includes the controller 22 being able to discern content of a signal(s) output from the position sensor, and supplied as an input to the controller (bi-directional arrow), and correlating it to the printhead, especially its individual fluid firing actuators to eject ink 35 to print an image. In a more detailed sense, this includes the controller being able to compare a signal of the position sensor indicative of a previous location 23, shown as a 4×7 matrix of pixels, to a signal of the position sensor indicative of a current location 25, shown as another 4×7 matrix of pixels, each having four hatched pixels translated from a first position 27 to a second, later position 29. Representatively, the four hatched pixels indicate relatively dark grayscale values on the media 16 that are observed in different orientations over time as a user or operator manipulates the housing 14 to print an image. In turn, the controller is to discern a difference between the previous and current locations and correlate same to the location of the printhead. The controller need also do this quickly and efficiently. In one instance, this means the controller will examine or search the current location for a presence, (such as the four hatched pixels) of the previous location.

In other aspects, the controller contemplates an intake checker 31 between the sensor and controller, or part and parcel of the controller, to assess validity of the signal(s) of the position sensor and to arrange the information thereof such that an actual or proximate relative distance D between the housing and the media can be ascertained. It also contemplates establishment of a threshold inquiry determining whether the housing of the printer is relatively close or far away from the media and whether such is sufficient to conduct further signal processing. Intuitively, operators of the handheld printer have freedom to lift the housing from the media and, if too far away from the media, the signal from the position sensor becomes fairly unusable, or invalid. On the other hand, touching the housing to the media or positioning it within a predetermined close interval renders the signal, and its attendant data, valid. Validity checking also considers application per every instance of a signal received from the sensor or application that occurs randomly, on specified occasions or at predetermined times.

In addition, the controller 22 contemplates a to-be-printed representation of an image 32, especially in bitmap form. In turn, it correlates the position of the printhead, especially individual actuators, to the image. It then prints the image with ink 35 on the media 16 according to the image pattern 36 in the pixels 38. A has-been-printed image 34 may also be stored or accessed by the controller to keep track of future printing and to determine whether the image has been printed completely or not. In structure, the controller embodies an ASIC, discrete IC chips, FPGA's, firmware, software, a microprocessor, combinations thereof or the like. Alternatively, the to-be-printed image 32 is dynamically updated to remove pixels that have been printed so that the has-been printed information 34 is merged with the to-be-printed information. In either, the controller further includes a memory to keep track of image data. The memory also includes storage and accessibility relative to position sensor signals and their manipulation to compute printer location. Memory will also find utility in general housekeeping matters, such as storage of an operating system, of sorts, display panel items, print jobs, user features, etc.

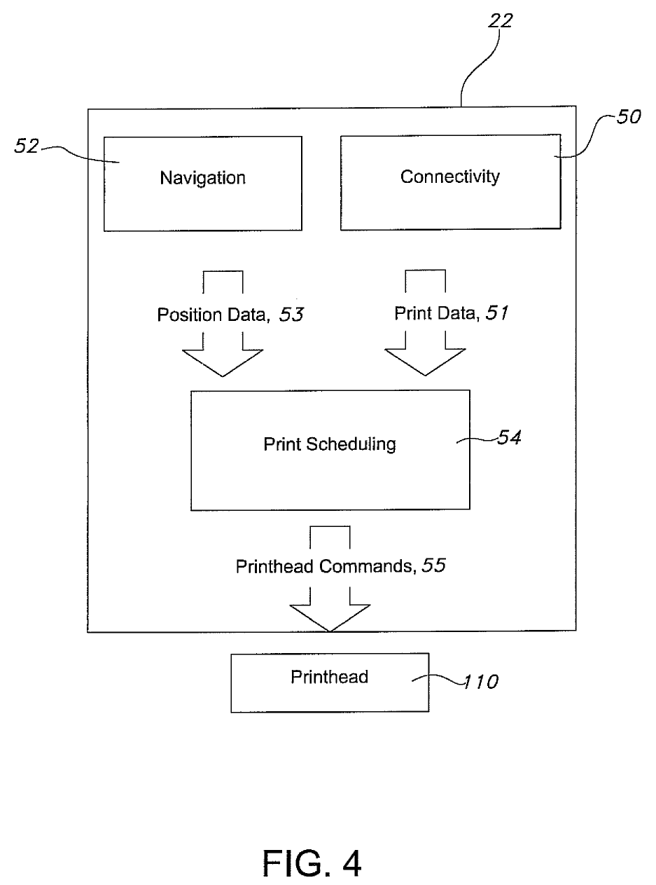

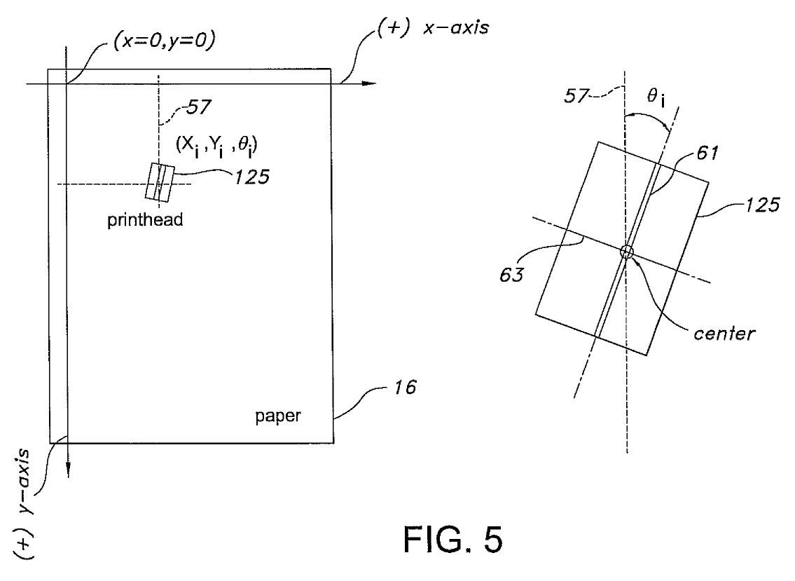

With reference to FIG. 4, a high-level accounting of the architecture of the controller of the handheld printer is described. On a macro scale, a controller is effectively all functional components within the boundary 22. Alternatively, it is only select components thereof. For instance, the intake checker [31] has already been mentioned as separable from the controller or part of the controller. The same is true of any memory. It is even plausible that the sensor [20] itself can be an integral part of the controller, despite being shown detached. Thus, skilled artisans will not prescribe any artificial, physical or functional boundaries to the controller, unless specifically claimed.

In arrangement, the controller includes shows three major modules: a connectivity module 50, a navigation module 52 and a print scheduling module 54. In use, the connectivity module 50 provides wired or wireless connection to a host, such as a computer or memory card, allowing the host to download print data to the handheld printer, especially the controller 22. The navigation module 52 keeps track of the location of handheld printer relative to the media. The print scheduling module 54 receives print data 51 from the connectivity module and printer position data 53 from the navigation module to generate the commands sent to the printhead 110, instructing it with printhead commands 55 to fire its fluid firing actuators at specific times.

With reference to FIG. 5, the position data [53] of the navigation module [52] describes an ideal position of the center of the actuator chip 125 at a specific point above a media 16 at a time Tᵢ using three components: xᵢ, yᵢ, and θᵢ. As shown, xᵢ shows how the printhead is positioned along the x-axis, yᵢ shows the position along the y-axis, and θᵢ shows how the printhead is rotated clockwise from the vertical 57. The rotation is further established by examining either a lengthwise line 61 passing through the center of the chip that generally parallels the long ends of the otherwise rectangular chip, as shown, or a widthwise line 63 passing through the center of the chip that generally parallels with short ends of the chip. As a convention, xᵢ and yᵢ will have units of 1/2400″ while θᵢ will have units expressed as degrees or radians. Naturally, these units will vary depending on the resolution of the positions sensors used in tracking the location of the printhead.

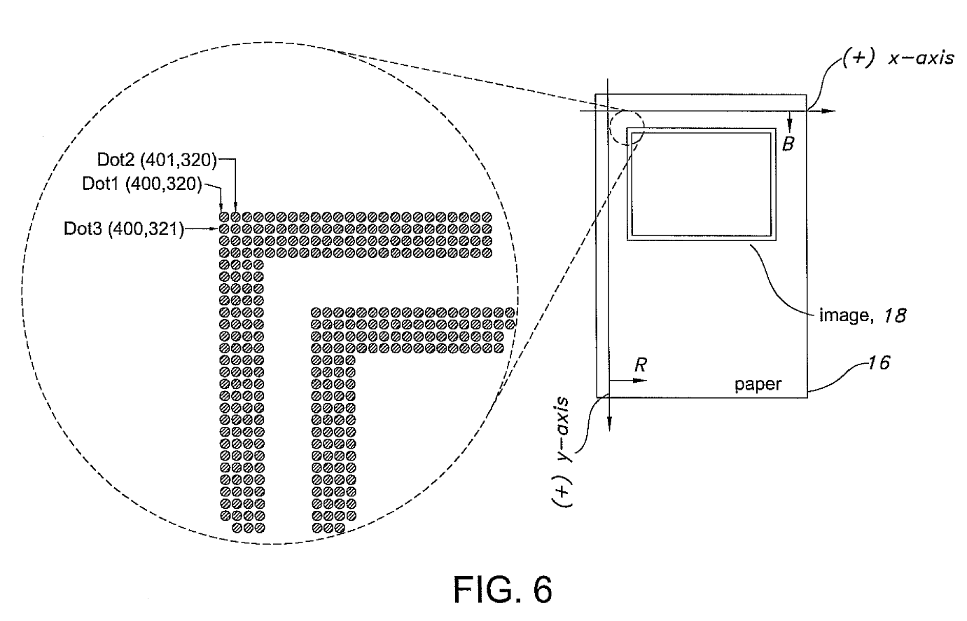

With reference to FIG. 6, the print data [51] of the connectivity module [50] describes how the ink drops of the actuator chip are to-be-placed on the media 16 as a function of how the to-be-printed image 18 looks. The location of the ink drops is described by two components, x_{d} and y_{d}, which also use a coordinate system composed of x- and y-axes as a reference. As a convention, the units of x_{d} and y_{d} are preferably in 1/600″ units. However, the units may vary depending on the size of the drops the printhead [110] supports. For example, Dot 1 has coordinates (x_{d}, y_{d}) at (400, 320) which means it is to-be-placed 400/600″ to the right R of the y-axis and 320/600″ below B of the x-axis. Similarly, Dot 2 has coordinates (x_{d}, y_{d}) at (401, 320) which means it is placed 401/600″ to the right R of the y-axis and 320/600″ below B of the x-axis, while Dot 3 has coordinates (x_{d}, y_{d}) at (400, 321) which means it is placed 400/600″ to the right R of the y-axis and 321/600″ below B of the x-axis.

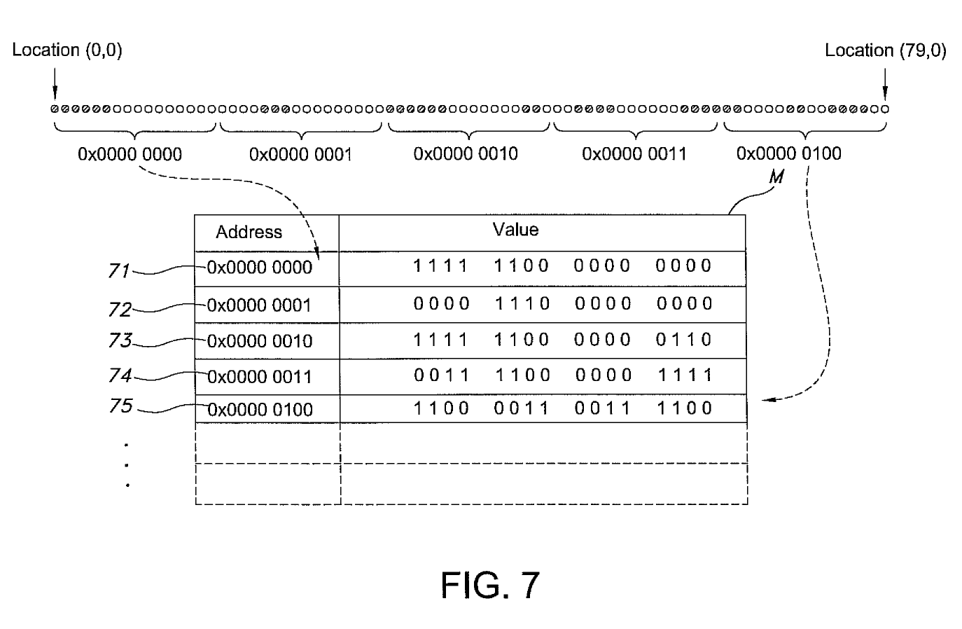

In controller memory (FIG. 7), the print data [51] in bitmap form is stored as a series of bits that represent the different locations in the print data. A bit “value” in memory M of ‘1’ indicates that a dot is present at a particular position while a ‘0’ value means that there is no dot for that location. For example, dots of print data are represented as bits in word-addressable blocks 71, 72, 73, 74, 75, 76, etc. of memory M. The print data for a first line of dots or raster starts with address 71 or 0x0000 0000. Thus, the first dot in the first raster, which is at position (0, 0), is the MSB or bit 15 of address 0x0000 0000. The bit values for the rest of the dots in the raster fill the succeeding memory addresses. Print data for raster 2 will start the address after the last address for raster 1, and so on. Of course, other memory schemes are possible.

With reference to FIG. 8, a simplified printhead 110 includes an actuator chip 125, as before. A nozzle plate 151 (in planar view looking at the actuator chip 125 from the vantage point V) includes simplified depictions of ten nozzles 1-10 situated over fluid firing actuators (FIG. 2) arranged in two columns, 1 and 11, each with five nozzles (nz) 1-5 and 6-10. A diameter of each nozzle is preferably arranged to eject ink drops of 1/600″ in diameter. Also, each nozzle has an offset from the center of the actuator chip 125 (also a center of the nozzle plate 151) that is described by polar coordinates (R_{nzli}, θ_{nzli}) where i is the nozzle number. R_{nzli} is the radial distance of the center of the nozzle from the center of the printhead chip, and θ_{nzli} describes how this radial distance is rotated clockwise from the horizontal H. As a convention, R_{nzli} will also be in 1/2400″ and θ_{nzli} will also be in degrees or radian.

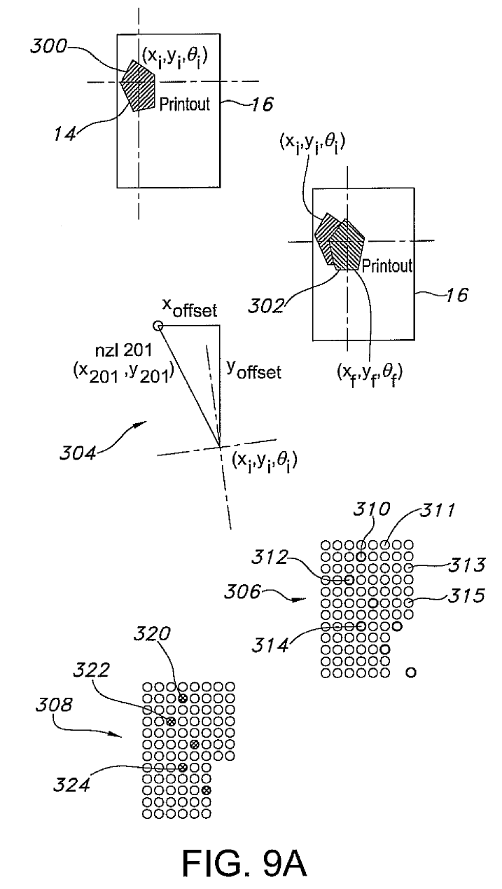

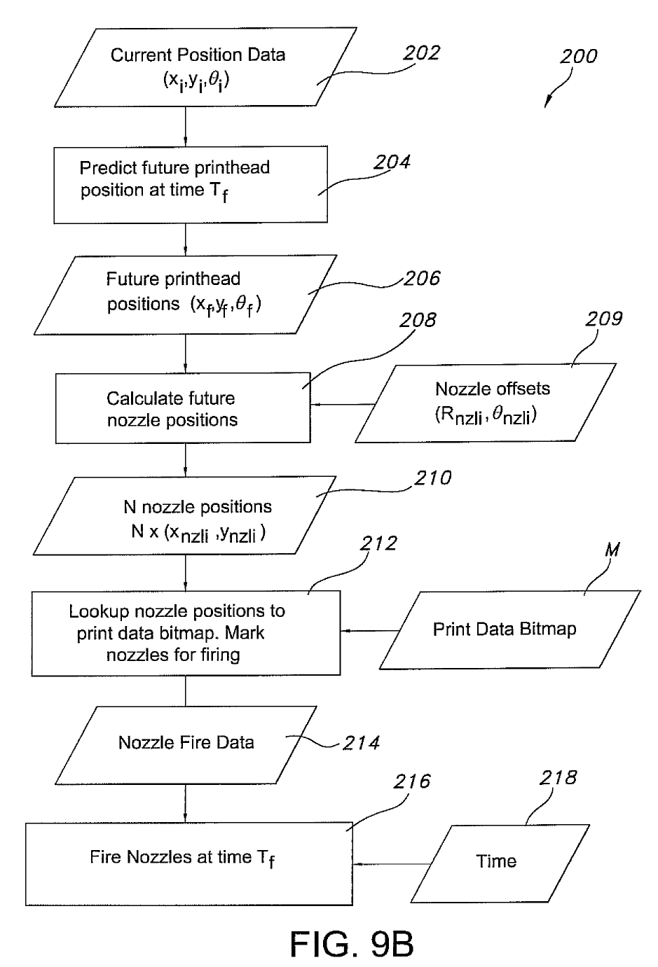

With the foregoing setting forth the physical and mathematical relationships in the handheld printer domain, FIG. 9 is a combined diagrammatic view and flow chart showing the flow 200 of print scheduling. In summary, the print scheduling starts at step 202 with a current position 300 of the printhead being received by the print scheduling module [54]. It is received as position data [53] from the navigation module [52] and is expressed in coordinates (xᵢ, yᵢ, θᵢ), as before. At this time, Tᵢ describes the location of the printer captured by the navigation module.

Using the position data, the future position data (x_{f}, y_{f}, T_{f}) of the printhead at location 302 is predicted (step 206) for future time T_{f} (step 204). In theory, future time T_{f} is the approximate time when all the print scheduling steps are done and the nozzles are ready for firing. Thus,

T_{f}=Tᵢ+Tₚ

where Tₚ is the processing time required to generate the printhead fire commands.

The future position data, will be used as reference to determine the position or location of the nozzles relative to the media at future time T_{f} (304). The output (step 210) of this step 208 should be N pairs of (x_{nzli}, y_{nzli}) which specify the future positions of all N nozzles in the printhead. Naturally, step 209 contemplates the input of all nozzle offsets as earlier described in polar coordinates relative to FIG. 8. At 306, each of the N nozzles is looked up in the print data bitmap, step 212, to determine whether a nozzle needs to fire ink or not. For instance, nozzles marked 310, 312, 314 are earmarked for firing, whereas nozzles marked 311, 313, 315 are not. Of course, the print data in bitmap form was earlier described in the memory M of FIG. 7. Thereafter, once all N nozzles have been looked up and marked for fire/no-fire, step 214, the nozzle fire data containing this information is processed and the nozzles are fired, step 216, when time T_{f} is reached. At 308, this includes firing nozzles 310, 312, and 314, for instance, to arrive at ink drops 320, 322, and 324 on a media. To keep track of time, a clock 218 or other counter is employed.

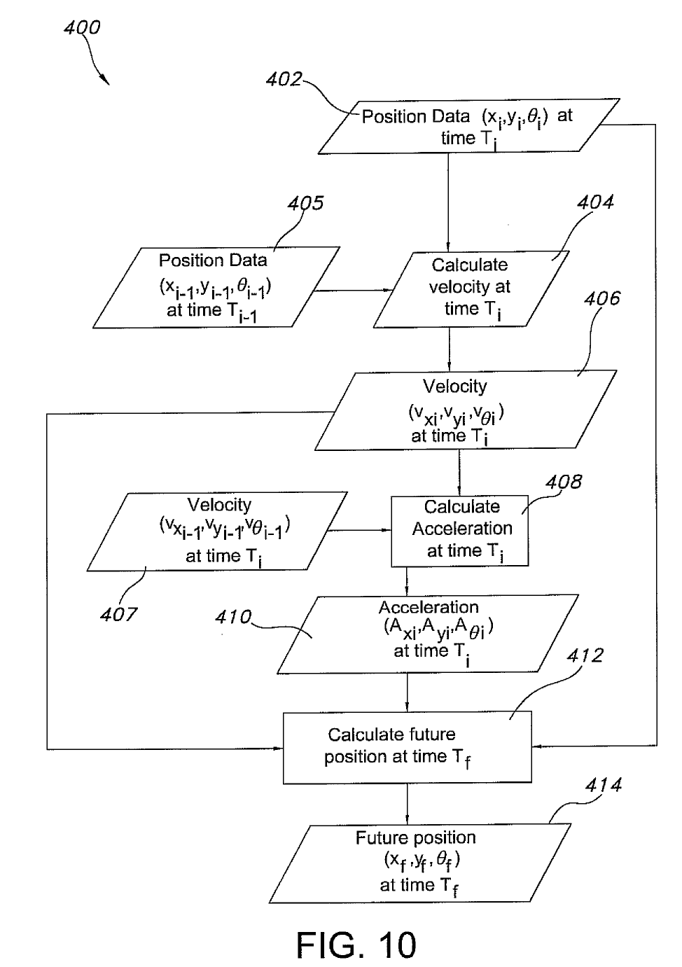

With reference to FIG. 10, a flow chart 400 is shown by which the future position of the printhead is calculated. Using the previous position data (xᵢ₋₁, yᵢ₋₁, θᵢ₋₁ (step 405) obtained at time Tᵢ₋₁ and the current position data (xᵢ, yᵢ, θᵢ) obtained at time Tᵢ (step 402), the current velocity (step 404) for x, y and θ-components are calculated using the following equations:

$${V}_{xi} = \frac{{x}_{i} - {x}_{i - 1}}{{T}_{i} - {T}_{i - 1}} , {V}_{yi} = \frac{{y}_{i} - {y}_{i - 1}}{{T}_{i} - {T}_{i - 1}} , {V}_{θ i} = \frac{{θ}_{i} - {θ}_{i - 1}}{{T}_{i} - {T}_{i - 1}}$$

The previous velocity components at time Tᵢ₋₁ (step 407) and the calculated velocity at time Tᵢ (step 406) are used to compute for the acceleration (step 408) in x, y, and θ-components for time Tᵢ, whereby the components of step 410 use the equations:

$${A}_{xi} = \frac{{V}_{xi} - {V}_{xi - 1}}{{T}_{i} - {T}_{i - 1}} , {A}_{yi} = \frac{{V}_{yi} - {V}_{yi - 1}}{{T}_{i} - {T}_{i - 1}} , {A}_{θ i} = \frac{{V}_{θ i} - {V}_{θ i - 1}}{{T}_{i} - {T}_{i - 1}}$$

The future x_{f}, y_{f} and θ_{f} positions (steps 412, 414) are calculated using the following:

$${x}_{f} = {x}_{i} + {V}_{xi} \cdot ( {T}_{f} - {T}_{i} ) + \frac{1}{2} ( {A}_{xi} \cdot {( {T}_{f} - {T}_{i} )}^{2} )$$

$${y}_{f} = {y}_{i} + {V}_{yi} \cdot ( {T}_{f} - {T}_{i} ) + \frac{1}{2} ( {A}_{yi} \cdot {( {T}_{f} - {T}_{i} )}^{2} )$$

$${θ}_{f} = {θ}_{i} + {V}_{θ i} \cdot ( {T}_{f} - {T}_{i} ) + \frac{1}{2} ( {A}_{θ i} \cdot {( {T}_{f} - {T}_{i} )}^{2} )$$

Ultimately, once the future position of the printhead itself is calculated, the positions of each of the nozzles in the printhead are calculated. For a specific or precise printhead, the location of the nozzles relative to the center of the printhead is constant and is described thru polar coordinates (R_{nzli}, θ_{nzli}), e.g., FIG. 7.

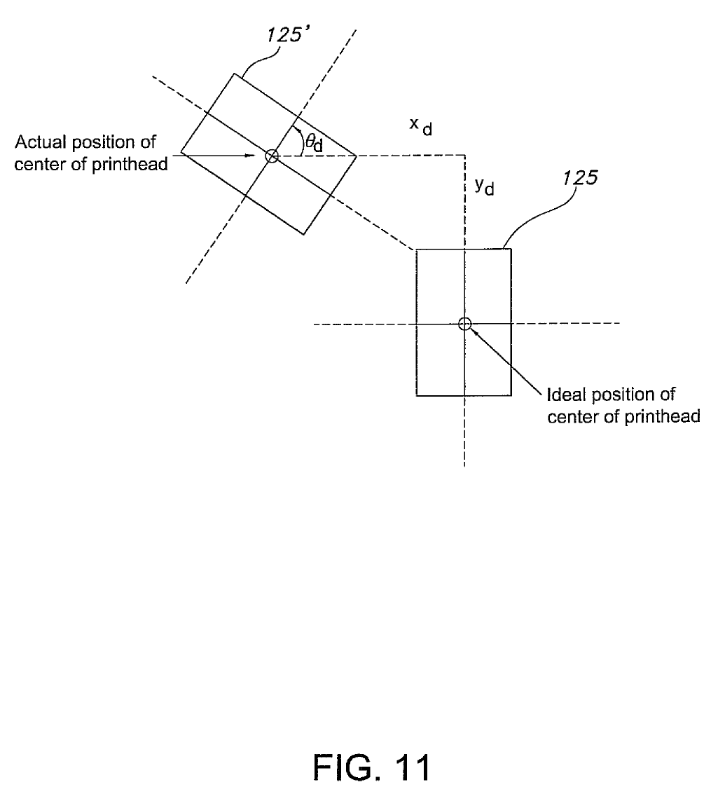

Appreciating that tolerance issues may abound in actual handheld printers, the center of the actuator chip and nozzle plate may not be perfectly aligned to the ideal or assumed reference point described by the position data. Thus, the actual location of the center is assumed to be misaligned from the ideal center by a certain amount (x_{d}, y_{d}, θ_{d}) as illustrated in FIG. 11 and skilled artisans will be able to determine their precise values.

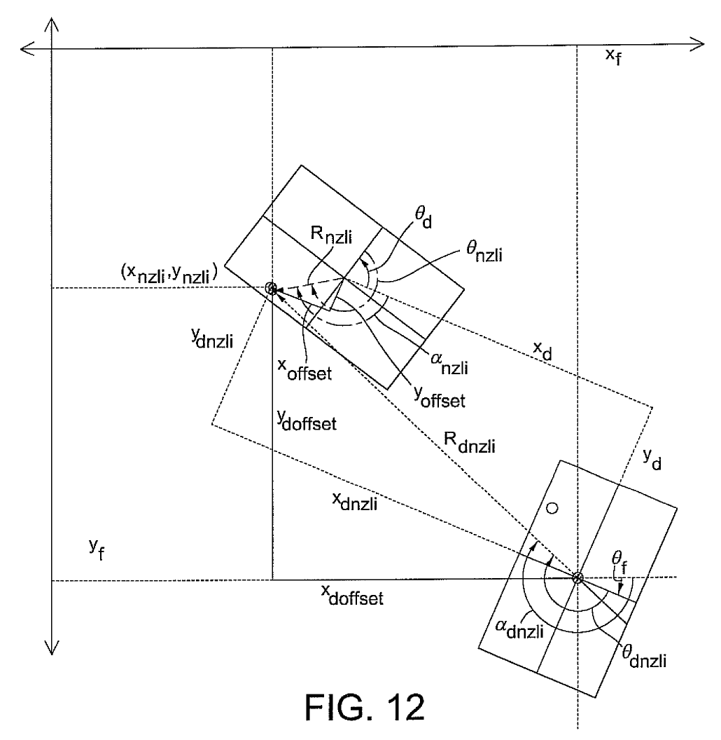

To correct the errors due to this misalignment, instead of directly using the values (R_{nzli}, θ_{nzli}) as the relative location of a certain nozzle from the printhead or actuator chip center, the position of the nozzles on the misaligned printhead chip is calculated relative to the ideal center of the printhead. This nozzle position is described by polar coordinates (R_{dnzli}, θ_{dnzli}). The value for (R_{dnzi}, θ_{dnzli}) will then be used to calculate for the position of the nozzles relative to the paper. FIG. 12 shows the various components that will be used to calculate for the position of nozzle i relative to the media, whereby the ideal printhead center is found relative to actuator chip 125 and the actual printhead center is found relative to actuator chip 125′. The values for the geographical components are given as:
R_{nzli}, θ_{nzli}=polar coordinates describing the position of nozzle i relative to the center of the actual printhead
x_{d}, y_{d}, θ_{d}=horizontal, vertical and angular position of the center of the actual printhead relative to the ideal position of the center of the printhead
x_{f}, y_{f}, θ_{f}=horizontal, vertical and angular position of the center of the ideal printhead center relative to paper

First, the values for x_{offset}, y_{offset} are calculated using the following equations:

x_{offset}=R_{nzli}·cos α_{nzli}

y_{offset}=R_{nzli}·sin α_{nzli}
where

α_{nzli}=θ_{d}+θ_{nzli}

The values for x_{dnzli}, y_{dnzli} are then calculated:

x_{dnzli}=(x_{offset}+x_{d})

y_{dnzli}=(y_{offset}+y_{d})

These are then used to obtain the value for R_{dnzl1}, θ_{dnzl1}

$${R}_{dnzli} = \sqrt{{x}_{dnzli}^{2} + {y}_{dnzli}^{2}}$$

$${θ}_{dnzli} = arctan \frac{{y}_{dnzli}}{{x}_{dnzli}} + 180 degress , {x}_{dnzli} < 0$$

$${θ}_{dnzli} = arctan \frac{{y}_{dnzli}}{{x}_{dnzli}} degrees , {x}_{dnzli} > 0 and {y}_{dnzli} \geq 0$$

$${θ}_{dnzli} = arctan \frac{{y}_{dnzli}}{{x}_{dnzli}} + 360 degrees , {x}_{dznli} > 0 and {y}_{dznli} < 0$$

$${θ}_{dznli} = 90 degrees , {x}_{dznli} = 0 and {y}_{dznli} > 0$$

$${θ}_{dznli} = 270 degrees , {x}_{dznli} = 0 and {y}_{dznli} < 0$$

Now, the values for R_{dnzli}, θ_{dnzli} will be used to calculate for the position of nozzle i, (x_{nzli}, y_{nzli}), relative to the media or paper. To do this, first the values for x_{doffset}, y_{doffset} are calculated by:

x_{doffset}=R_{dzli}·cos α_{dnzli}

y_{doffset}=R_{dnzli}·sin α_{dnzli}
where

α_{dnzli}+θ_{f}+θ_{dnzli}

The values for x_{nzli} and y_{nzli} are then calculated using the following equations:

S_{xnzli}=(x_{doffset}+x_{f})/4

S_{ynzli}=(y_{doffset}+y_{f})/4

The division by 4 is used to convert the unit from 1/2400″ to 1/600″, which is obtained by:

$$\frac{1}{2400} * \frac{600}{600} = \frac{600}{2400} * \frac{1}{600} = \frac{1}{4} * \frac{1}{600} inch$$

The values for S_{xnzli}, S_{ynzli}, which describe the position of nozzle i on the paper, are likely to be real numbers. This means that the nozzle may be in a location that will straddle across two or more dot positions in the print bitmap data. One way to resolve this issue is to round off the nozzle position into the nearest whole number value in a straightforward manner and compare that nozzle position to the corresponding dot in the bitmap. However, this could result to grossly misplaced dots and poor print quality. As such, another way for this is to define a range of values for the nozzle position to be considered valid and that position will be rounded off to the nearest whole number value.

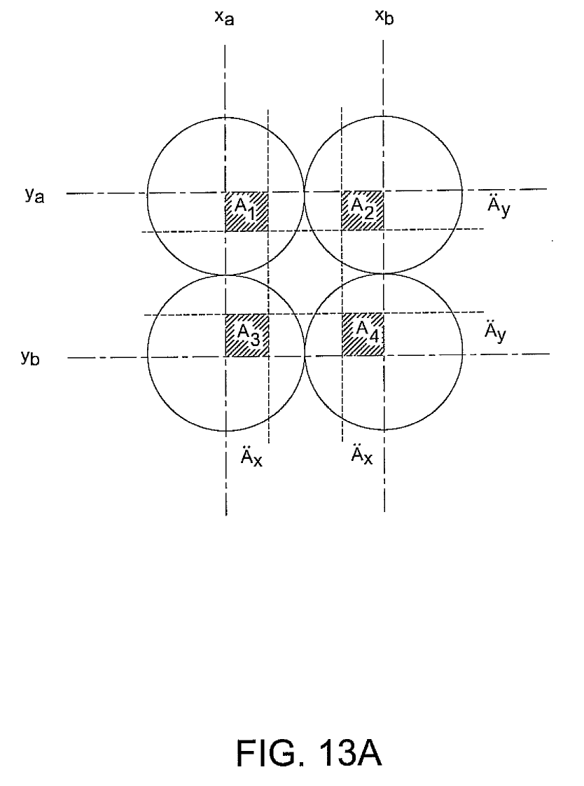

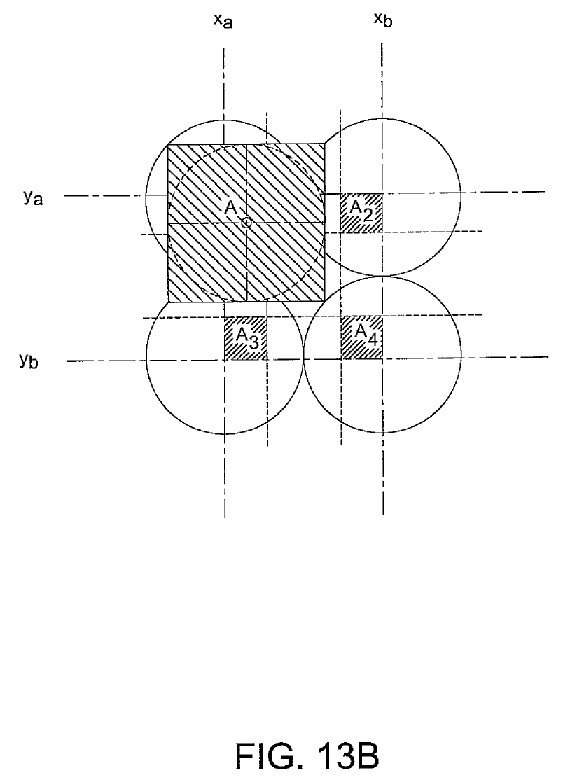

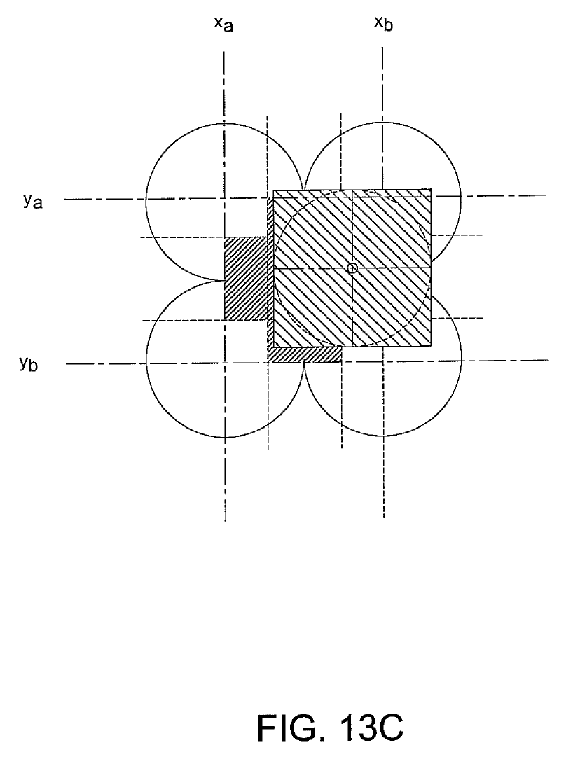

With reference to FIGS. 13A-13C, FIG. 13A shows four adjacent print bitmap dot positions at (xₐ, yₐ), (x_{b}, yₐ), (xₐ, y_{b}) and (x_{b}, y_{b}). The valid areas are those shaded which are Area A1 ((xa,ya), (xa+Δx, ya), (xa, ya+Δy), (xa+Δx, ya+Δy)), Area A2 ((xb−Δx,ya), (xb, ya), (xb−Δx, ya+Δy), (xb, ya+Δy)), Area A3 ((xa,yb−Δy), (xa+Δx, yb−Δy), (xa, yb), (xa+Δx, yb)) and Area A4 ((xb−Δx,yb−Δy), (xb, yb−Δy), (xb−Δx, y_{b}), (xb, yb)). In turn, nozzle positions that fall within these areas are considered valid and will be rounded off to the nearest whole number dot position. In FIG. 13B, for example, the nozzle is positioned within Area A1 and its position will be rounded off to (xₐ, yₐ) In FIG. 13C, in contrast, the nozzle is placed outside of the four valid areas and will not be fired in this cycle of position data sample. Also, skilled artisans will be able to separately determine the values for Δx and Δy through various evaluation and calibration steps. However, decreasing the values for Δx and Δy is likely to result to more accurately placed dots but may require a longer time to finish a given print job. On the other hand, increasing the values for Δx and Δy will reduce the time to complete the print job but may result to lower print quality.

Using the process discussed above, the whole number values for the nozzle position (x_{nzli}, Y_{nzli}) are determined by:
S_{xnzli}, S_{ynzli} [symbol] X_{nzli}, Y_{nzli}

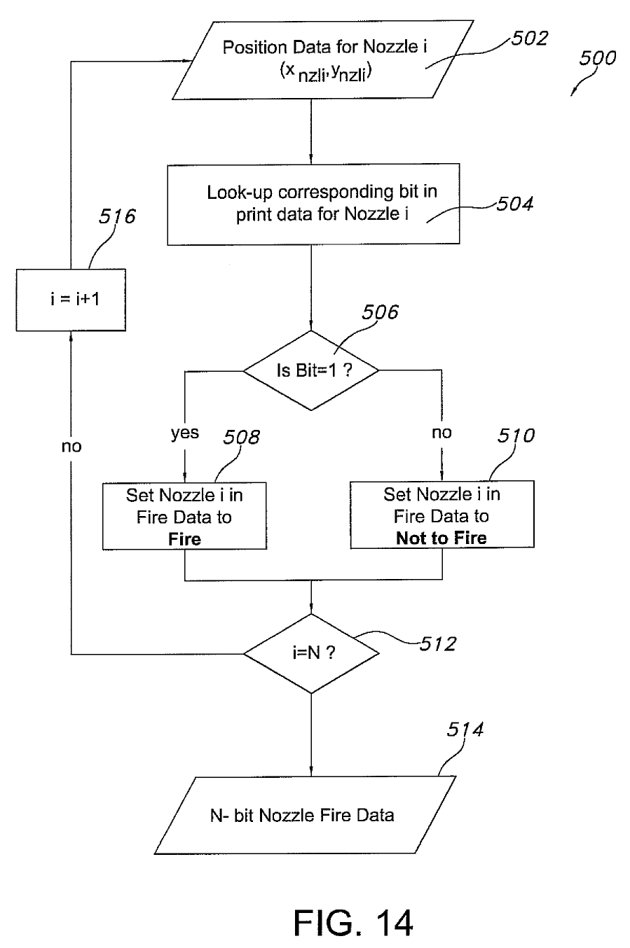

Once all the nozzle positions have been calculated, there should be (at step 210, FIG. 9) N sets of (x_{nzli}, y_{nzli})—where N is the number of nozzles in the printhead—which will be used in the Nozzle-Bitmap Lookup process (at step 212, FIG. 9). In more detail, the Nozzle-Bitmap Lookup process at step 212, FIG. 9, is shown as flow chart 500 in FIG. 14.

Beginning with the position data for a nozzle i (step 502), a look-up occurs at step 504 for the corresponding bit in the print data [51] in memory M [FIG. 7]. If the bit is 1, step 506, the fluid firing actuator or nozzle is deemed to be fired, and such is set as firing data to actuate the printhead at step 508. Conversely, if the bit is 0, step 506, the fluid firing actuator or nozzle is deemed not to be fired, and such is set as firing data at step 510.

Appreciating N-nozzle or fluid firing actuators exists, if the nozzle numbered i is equal to the number N, step 512, the look-up process is finished and the N-bit nozzle fire data is complete at step 514 (see, also the printhead commands 55, FIG. 4 from the print scheduling module 54 to the printhead 110). On the other hand, if the nozzle numbered i is not equal to the number N, step 512, more nozzles exist and the look-up process increments the nozzle to-be-looked-up by one, step 516. The process repeats at step 502 until the N-bit fire data at step 514 to actuate the printhead is wholly known.

In comparing the absolute nozzle position to the print data bitmap, however, only the relevant 16-bit data corresponding to the nozzle position is to be read from memory M [FIG. 7]. Since each print data is equivalent to 1 bit (as opposed to non-print data being a 0 bit), the nozzle position itself will also correspond to a 1 bit in the bitmap. Therefore, an algorithm to determine which memory location holds the relevant data needs to be defined, per below.

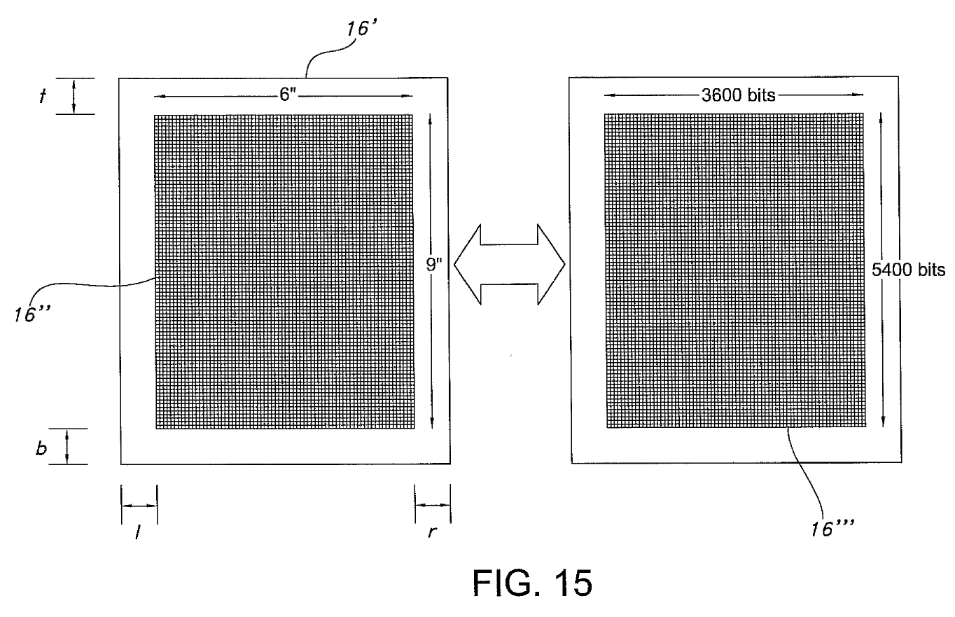

With reference to FIG. 15, certain assumptions exist. That is, if the maximum dimension of the print media for the handheld printer is an 8.5″×11″ media 16′ and the maximum printable area is 6″×9″ labeled 16″ (after considering a 1″ margin on the top t and bottom b sides of the page and 1.25″ margin on the left l and right r sides), the computation for the number of dots for a single print job is as follows (assuming a print resolution of 600 dpi):

$$6 inches \times \frac{600 dots}{inch} = 3600 dots 3600 bits$$

$$9 inches \times \frac{600 dots}{inch} = 5400 dots 5400 bits$$

, labeled 16′″. Thus, the equivalence means that the range of values for the nozzle positions will be:

for the x position: [0:3599]

for the y position: [0:5399]

Assuming that the memory block where the print data bitmap is stored is word-addressable or that 16 bits of data can be accessed at a time, one line of print data is stored in 225 memory locations.

$$3600 bits \times \frac{1 memory location}{16 bits} = 225 memory locations$$

Therefore, to search for the memory location of the print data bit (e.g., the “1”) corresponding to the nozzle position, the following equation is used:

memory location(address)=y_{nzli}*225)+(x_{nzli}div16)

Within the 16-bit data accessed from memory, only 1 bit corresponds to the print data bit. To further decode the bit location of the print data bit, the following equation is used:

bit location=x_{nzli}modulo16

Each of the N nozzles is looked up to identify whether it needs to fire or not. If the print data bit corresponding to a particular nozzle is set to ‘1’, then it is marked to fire, as before. If ‘0’, then don't fire. Then, the bit corresponding to the nozzle being scheduled is cleared (set to ‘0’). This is done to ensure that no ink is fired again if ever a nozzle passes over the same point in the page.

After the Nozzle-Bitmap Look-up process is done for all N nozzles, the data specifying whether each of the N nozzles will fire or not are sent to the printhead to fire the marked nozzles, e.g., step 514, FIG. 14 and

In any embodiment, certain advantages of the invention over the prior art are readily apparent. For example, the invention at hand provides enhanced computational processing for navigating a handheld printer, ultimately improving print quality regardless of user manipulation, speed, orientation and pattern. It also adds a simple architecture for performing same.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be imported, for modifications will become obvious to those skilled in the art upon reading this disclosure and may be made without departing from the spirit or scope of the invention. Relatively apparent modifications, of course, include combining the various features of one or more figures with the features of one or more of other figures.

What is claimed:

1. A handheld printer to be manipulated back and forth by an operator over a media during use to print an image on the media, comprising:
a hand maneuverable housing for the operators
an inkjet printhead on or in the housing to print the image by ejecting ink from a plurality of fluid firing actuators of an actuator chip;
a controller communicating with each said fluid firing actuators to eject ink or not, the controller in operable connection with a memory having firing data for the each said fluid firing actuators; and
a position sensor communicating with the controller to provide a location of the housing during use, an output of the position sensor indicating a current position of the housing and over time a previous position of the housing,
wherein the controller is operable to compare the current position to the previous position to ascertain a relative location of the printhead to the image, the controller further operable to correlate the each said fluid firing actuators to the relative location by establishing an ideal position of a center of the actuator chip and figuring an offset from the center to the each said fluid firing actuators.

2. The handheld printer of claim 1, wherein the controller is operable to establish the ideal position of the center of the actuator chip by determining two orthogonal variables of the center and one rotational variable of a line passing through the center relative to an orthogonal orientation of the media.

3. The handheld printer of claim 1, wherein the controller is operable to compare the current position: to the previous position to predict a future printhead position at a given time, the relative location of the each said fluid firing actuators also being able to be predicted by the controller for the given time.

4. The handheld printer of claim 1, wherein, the memory is arranged as a plurality of addresses of rasters and the firing data is a 1 bit to eject ink and a 0 bit to avoid ejecting ink.

5. The handheld printer of claim 1, wherein the controller is operable to use pluralities of values corresponding to the current position and the previous position to calculate a velocity and acceleration of the housing.

6. The handheld printer of claim 1, wherein the controller is operable to determining an actual position of the center of the actuator chip relative to the ideal position.

7. The handheld printer of claim 1, wherein the position sensor is an optical sensor for transmitting and receiving light.

8. In a handheld printer having a housing to be manipulated back and forth by an operator over a media during use to print an image on the media, a method of scheduling printing, comprising:
providing an actuator chip on the housing, the actuator chip having a plurality of fluid firing actuators operable to eject ink to print the image upon firing commands of a controller in the housing;
establishing an ideal position of a center of the actuator chip relative to the media;
figuring an actual position of the center of the actuator chip relative to the ideal position; and
examining a memory having firing data for each said fluid firing actuators at the actual position, the controller commanding the each said fluid firing actuators to eject ink or not.

9. The method of claim 8, further including figuring a geographical offset from the center of the actuator chip to each said fluid firing actuators, the offset being used in ascertaining a position relative to the image to be printed on the media.

10. The method of claim 8, further including determining a previous position and a current position of the housing during use and predicting a future position, the future position further including a determination of a location of the each said fluid firing actuators.

11. The method of claim 8, further including determining a velocity and an acceleration of the housing during use.

12. The method of claim 8, further including resolving whether an actual location of a nozzle of the each said fluid firing actuators corresponds to the memory having the firing data for the each said fluid firing actuators

13. A handheld printer to be manipulated back and forth by an operator over a media during use to print an image on the media, comprising:
a hand maneuverable housing for the operator;
an inkjet printhead on or in the housing to print the image by ejecting ink from a plurality of fluid firing actuators of an actuator chip on the printhead; and
a controller communicating with each said fluid firing actuators to eject ink or not, the controller in operable connection with a memory having firing data for the each said fluid firing actuators at a position relative to the media; the controller operable to correlate the each said fluid firing actuators to the position by a) establishing an ideal position of a center of the actuator chip and figuring an offset from the center to the each said fluid firing actuators and b) determining an actual position of the center of the actuator chip relative to the ideal position, including the figured offset.

14. The handheld printer of claim 13, further including a position sensor communicating with the controller to provide a location of the housing during use, an output of the position sensor indicating a current position of the housing and over time a previous position of the housing, wherein the controller is operable to compare the current position to the previous position to ascertain the position relative to the media.

15. The handheld printer of claim 13, wherein the controller is operable to establish the ideal position of the center of the actuator chip by determining two orthogonal variables of the center and one rotational variable of a line passing through the center relative to an orthogonal orientation of the media.

16. The handheld printer of claim 14, wherein the controller is operable to compare the current position to the previous position to predict a future printhead position at a given time, a location of the each said fluid firing actuators also being able to be predicted by the controller for the given time.
